(19) United States
(12) Patent Application Publication
(10) Pub. No.: US 2018/0295028 A1
(43) Pub. Date: Oct. 11, 2018

(54) METHOD AND APPARATUS OF CONFIGURING AND MAINTAINING SMART WIFI DEVICE, DEVICE AND COMPUTER STORAGE MEDIUM

(71) Applicant: BAIDU ONLINE NETWORK TECHNOLOGY (BEIJING) CO., LTD., Haidian District Beijing (CN)

(72) Inventor: Yan BAO, Haidian District Beijing (CN)

(73) Assignee: BAIDU ONLINE NETWORK TECHNOLOGY (BEIJING) CO., LTD ., Haidian District Beijing (CN)

(21) Appl. No.: 15/949,918

(22) Filed: Apr. 10, 2018

(30) Foreign Application Priority Data
Apr. 11, 2017 (CN) 2017102333224

(51) Int. Cl. H04L 12/24; H04W 12/08; H04W 76/10

(52) U.S. Cl. CPC H04L 41/0889; H04L 41/0806; H04L 41/0686; H04L 41/0645; H04W 76/10; H04W 12/08

(57) ABSTRACT

A method and apparatus of configuring a smart WiFi device, a device and a computer storage medium is provided. In the configuring method; a terminal determines the WiFi device to be configured; the terminal uses an external AP function of the WiFi device to establish a connection with the WiFi device; the terminal obtains configuration information; the terminal sends the configuration information to the WiFi device through the connection so that the WiFi device performs configuration according to the sent configuration information. A method and apparatus for maintaining a WiFi device, a device and a computer storage medium is provided where: a terminal determines the WiFi device to be maintained; the terminal uses an external AP function of the WiFi device to establish a connection; the terminal detects a cause of the fault of the WiFi; the terminal generates maintenance information about the cause of the fault.

The present application claims the priority of Chinese Patent Application No. 2017102333224, filed on Apr. 11, 2017, with the title of “Method and apparatus of configuring and maintaining smart WiFi device, device and computer storage medium”.

### FIELD OF THE DISCLOSURE

The present disclosure relates to the technical field of smart home, and particularly to a method and apparatus of configuring and maintaining a smart WiFi device, a device and a computer storage medium.

### BACKGROUND OF THE DISCLOSURE

As mobile internet develops, smart WiFi devices prevail in many fields, for example smart TV sets, smart lamps, smart purifiers at home. These smart WiFi devices may display colorful content to users via a network, and meanwhile can be remotely controlled by users via the network. Therefore, how to accurately and quickly perform network configuration for the smart WiFi devices and find causes for faults of the smart WiFi device is of great importance.

In the prior art, network configuration is mostly performed for a smart WiFi device by connecting an AP (Access Point) of the smart WiFi device via a mobile terminal such as a mobile phone, and inputting a designated web address in a browser. Therefore, the prior art causes complicated manual participation steps to the user, and requires certain learning costs. Furthermore, the smart WiFi device cannot verify the network configuration information input by the user. If the network configuration information is erroneous, the user cannot know the error in time so that the configuration efficiency is low. When the smart WiFi device malfunctions, the user usually restores factory setting of the smart WiFi device or contacts a professional for repair. When the smart WiFi device is repaired by restoring the factory setting, this may reduce the hardware service life of the device and affect software service of the device, and when re-installation is performed, the user further needs to perform configuration operations again; when the professional is contacted for repair, costs are high and abnormal situations cannot be excluded in time, which causes a lower maintenance efficiency to the user.

### SUMMARY OF THE DISCLOSURE

In view of the above, the present disclosure first provides a method and apparatus of configuring a smart WiFi device, a device and a computer storage medium, to simplify the user's configuration steps and improve the user's configuration efficiency.

A technical solution employed by the present disclosure to solve the technical problem provides a method of configuring a smart WiFi device, the method comprising: a terminal determines the smart WiFi device to be configured; the terminal uses an external AP function of the smart WiFi device to establish a connection with the smart WiFi device; the terminal obtains configuration information; the terminal sends the configuration information to the smart WiFi device through the connection so that the smart WiFi device performs configuration according to the sent configuration information.

According to a preferred embodiment of the present disclosure, the terminal determining the smart WiFi device to be configured comprises: according to a name of the smart WiFi device input by the user, the terminal determines the smart WiFi device corresponding to the name as the smart WiFi device to be configured; or after scanning the smart WiFi device, the terminal determines a smart WiFi device selected by the user from the scanned smart WiFi devices as the smart WiFi device to be configured.

According to a preferred embodiment of the present disclosure, before the terminal determining the smart WiFi device to be configured, the method further comprises: obtaining the user's identity information; verifying the user's identity information.

According to a preferred embodiment of the present disclosure, the terminal using an external AP function of the smart WiFi device to establish a connection with the smart WiFi device comprises: the terminal in a station mode detects the smart WiFi device in an AP mode; the terminal sends a connection establishment request to the smart WiFi device; and establishes the connection with the smart WiFi device after handshake for predetermined times.

According to a preferred embodiment of the present disclosure, the terminal obtaining configuration information comprises: obtaining user-input configuration information or obtaining configuration information already stored locally.

According to a preferred embodiment of the present disclosure, after the terminal obtaining the configuration information, the method further comprises: the terminal verifies the obtained configuration information; if the verification passes, continues to send the configuration information to the smart WiFi device through the connection.

A technical solution employed by the present disclosure to solve the technical problem provides an apparatus for configuring a smart WiFi device, the apparatus being located at a terminal and comprising: a first determining unit configured to determine the smart WiFi device to be configured; a first connecting unit configured to use an external AP function of the smart WiFi device to establish a connection with the smart WiFi device; an obtaining unit configured to obtain configuration information; a configuring unit configured to send the configuration information to the smart WiFi device through the connection so that the smart WiFi device performs configuration according to the sent configuration information.

According to a preferred embodiment of the present disclosure, upon determining the smart WiFi device to be configured, the first determining unit specifically performs: according to a name of the smart WiFi device input by the user, determining the smart WiFi device corresponding to the name as the smart WiFi device to be configured; or after scanning the smart WiFi device, determining a smart WiFi device selected by the user from the scanned smart WiFi devices as the smart WiFi device to be configured.

According to a preferred embodiment of the present disclosure, upon using an external AP function of the smart WiFi device to establish a connection with the smart WiFi device, the first connecting unit specifically performs: the terminal in a station mode detects the smart WiFi device in an AP mode; the terminal sends a connection establishment request to the smart WiFi device; establishes the connection with the smart WiFi device after handshake for predetermined times.

According to a preferred embodiment of the present disclosure, upon obtaining configuration information, the obtaining unit specifically performs: obtaining user-input configuration information or obtaining configuration information already stored locally.

The present disclosure further provides a method and apparatus of maintaining a smart WiFi device, a device and a computer storage medium, to implement reduction of the user's costs and improve the user's maintenance efficiency.

A technical solution employed by the present disclosure to solve the technical problem provides a method of maintaining a smart WiFi device, the method comprising: a terminal determines the smart WiFi device to be maintained; the terminal uses an external AP function of the smart WiFi device to establish a connection with the smart WiFi device; the terminal detects a cause of the fault of the smart WiFi device through the connection; the terminal generates maintenance information according to the cause of the fault.

According to a preferred embodiment of the present disclosure, the terminal determining the smart WiFi device to be maintained comprises: according to a name of the smart WiFi device input by the user, the terminal determines the smart WiFi device corresponding to the name as the smart WiFi device to be maintained; or after scanning the smart WiFi device, the terminal determines a smart WiFi device selected by the user from the scanned smart WiFi devices as the smart WiFi device to be maintained; or the terminal, according to the name of the smart WiFi device sent by a server, determines the smart WiFi device corresponding to the name as the smart WiFi device to be maintained.

According to a preferred embodiment of the present disclosure, before the terminal determining the smart WiFi device to be maintained, the method further comprises: obtaining the user's identity information; verifying the user's identity information.

According to a preferred embodiment of the present disclosure, using an external AP function of the smart WiFi device to establish a connection with the smart WiFi device comprises: the terminal in a station mode detects the smart WiFi device in an AP mode; the terminal sends a connection establishment request to the smart WiFi device; and establishes the connection with the smart WiFi device after handshake for predetermined times.

According to a preferred embodiment of the present disclosure, the terminal detecting a cause of the fault of the smart WiFi device through the connection comprises: the terminal sending a detection instruction to the smart WiFi device through the established connection; obtaining state information returned by the smart WiFi device; obtaining the cause of the fault according to the state information.

According to a preferred embodiment of the present disclosure, the terminal generating maintenance information according to the cause of the fault comprises: obtaining a solution corresponding to the cause of the fault according to the cause of the fault; providing the solution to the user.

A technical solution employed by the present disclosure to solve the technical problem provides an apparatus for maintaining a smart WiFi device, the apparatus being located at a terminal and comprising: a second determining unit configured to determine the smart WiFi device to be maintained; a second connecting unit configured to use an external AP function of the smart WiFi device to establish a connection with the smart WiFi device; a detecting unit configured to detect a cause of the fault of the smart WiFi device through the connection; a maintaining unit configured to generate maintenance information according to the cause of the fault.

According to a preferred embodiment of the present disclosure, upon determining the smart WiFi device to be maintained, the second determining unit specifically performs: according to a name of the smart WiFi device input by the user, determining the smart WiFi device corresponding to the name as the smart WiFi device to be maintained; or after scanning the smart WiFi device, determining a smart WiFi device selected by the user from the scanned smart WiFi devices as the smart WiFi device to be maintained; or according to the name of the smart WiFi device sent by a server, determining the smart WiFi device corresponding to the name as the smart WiFi device to be maintained.

According to a preferred embodiment of the present disclosure, upon using an external AP function of the smart WiFi device to establish a connection with the smart WiFi device, the second connecting unit specifically performs: the second connecting unit in a station mode detects the smart WiFi device in an AP mode; sending a connection establishment request to the smart WiFi device; establishing the connection with the smart WiFi device after handshake for predetermined times.

According to a preferred embodiment of the present disclosure, upon detecting the cause of the fault of the smart WiFi device through the connection, the detecting unit specifically performs: sending a detection instruction to the smart WiFi device through the established connection; obtaining state information returned by the smart WiFi device; obtaining the cause of the fault according to the state information.

As can be seen from the above technical solutions of the present disclosure, the connection is established between the terminal and the smart WiFi device through the external AP function of the smart WiFi device, thereby simplifying the user's steps in configuring and maintaining the smart WiFi device, and improving the user's efficiency in configuring and maintaining the smart WiFi device.

### BRIEF DESCRIPTION OF DRAWINGS

FIG. 1 is a schematic diagram of a configuring method according to an embodiment of the present disclosure.

FIG. 2 is a flow chart of a configuring method according to an embodiment of the present disclosure.

FIG. 3 is a structural schematic diagram of a configuring apparatus according to an embodiment of the present disclosure.

FIG. 4 is a flow chart of a maintaining method according to an embodiment of the present disclosure.

FIG. 5 is a structural schematic diagram of a maintaining apparatus according to an embodiment of the present disclosure.

FIG. 6 is a block diagram of a computer system/server according to an embodiment of the present disclosure.

### DETAILED DESCRIPTION OF PREFERRED EMBODIMENTS

The present disclosure will be described in detail in conjunction with figures and specific embodiments to make objectives, technical solutions and advantages of the present disclosure more apparent.

Terms used in embodiments of the present disclosure are only intended to describe specific embodiments, not to limit the present disclosure. Singular forms “a”, “said” and “the” used in embodiments and claims of the present disclosure are also intended to include plural forms, unless other senses are clearly defined in the context.

It should be appreciated that the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

Depending on the context, the word “if” as used herein may be construed as “at the time when . . . ” or “when . . . ” or “responsive to determining” or “responsive to detecting”. Similarly, depending on the context, phrases “if . . . is determined” or “if . . . (stated condition or event) is detected” may be construed as “when . . . is determined” or “responsive to determining” or “when . . . (stated condition or event) is detected” or “responsive to detecting (stated condition or event)”.

In the present disclosure, the smart WiFi device is a smart household electrical appliance such as a smart TV set, a smart refrigerator or a smart air conditioner which has a WiFi module and can be connected to a wireless network. After the smart WiFi device is connected to the network, it can display colorful content on the network to the user, and can be controlled remotely by the user via the network. Therefore, how to perform quick and accurate network configuration for the smart WiFi device is a focus of people's concerns. The present disclosure first provides a method of configuring a smart WiFi device: using the smart WiFi device's external AP function to establish a connection between a terminal and the smart WiFi device, and performing network configuration for the smart WiFi device via the terminal, thereby simplifying the user's operation steps and further improving the user's configuration efficiency.

Certainly, it is possible to implement, in addition to the network configuration of the smart WiFi device, other configurations for example other functional configurations such as update configuration and turn-on and turn-off configuration of the smart WiFi device in the manner provided by the present disclosure. Description is performed by taking network configuration as an example in the embodiment of the present disclosure.

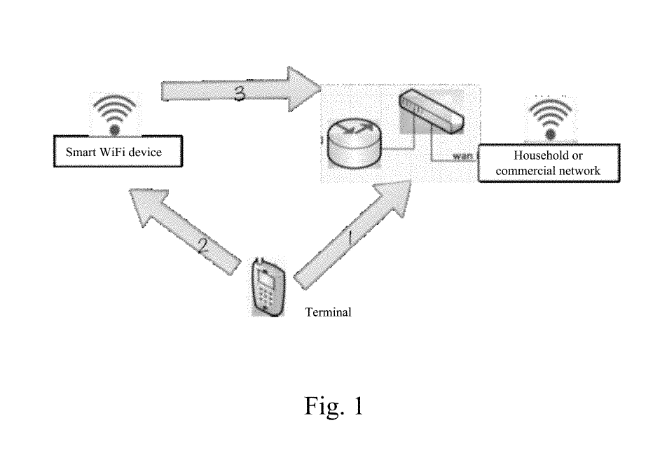

First, the whole procedure of performing network configuration for the smart WiFi device is described with reference to FIG. 1. First, the terminal verifies the user's identity information, and after successful verification, the terminal determines the smart WiFi device selected by the user as the smart WiFi device to be configured. After determining the smart WiFi device to be configured, the terminal verifies the obtained network configuration information (a procedure as shown by arrow 1 in FIG. 1). Upon completion of verification of the network configuration information, the terminal sends the successfully-verified network configuration information to the smart WiFi device through an already-established connection (a procedure as shown by arrow 2 in FIG. 1). The smart WiFi device connects to the network according to the network configuration information sent by the terminal (a procedure as shown by arrow 3 in FIG. 1).

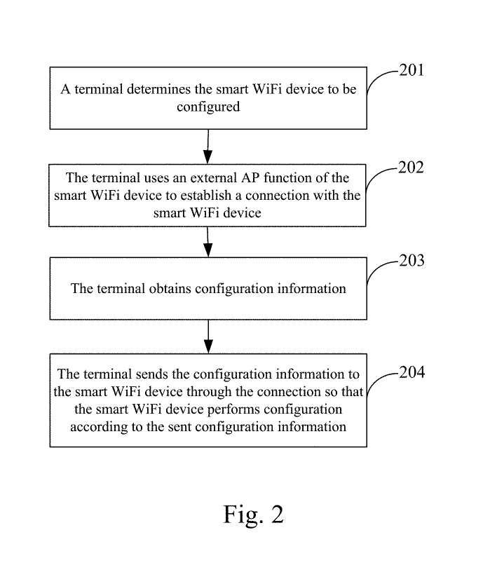

FIG. 2 is a flow chart of a method of configuring the smart WiFi device according to an embodiment of the present disclosure. As shown in FIG. 2, the method comprises:

In 201, the terminal determines the smart WiFi device to be configured.

In this step, the terminal determines the smart WiFi device to be configured according to the user's actual demands.

In the present disclosure, the terminal may be a mobile device such as a mobile phone, a notebook computer, a tablet computer or a PDA (Personal Digital Assistant). The present disclosure does not limit the type of the terminal.

Optionally, in a specific implementing procedure of the present embodiment, according to a name of the smart WiFi device input by the user, the terminal determines the smart WiFi device corresponding to the name as the smart WiFi device to be configured. For example, if the user inputs “ [symbol] (Gree air conditioner)”, the terminal determines “ [symbol] ” as the smart WiFi device to be configured; if there are multiple smart WiFi devices of the same type in the room, the user may input more detailed information to ensure the smart WiFi device determined by the terminal as the smart WiFi device that the user actually needs to configure, for example, the user may input “ [symbol] (bedroom Gree air conditioner)”, and the terminal may determine the bedroom Gree air conditioner as the smart WiFi device to be configured. It is further possible that after scanning the smart WiFi device, the terminal determines the smart WiFi device selected by the user from the scanned smart WiFi devices as the smart WiFi device to be configured. The terminal obtains all smart WiFi devices in the room by scanning to ensure that un-configured or newly-installed smart WiFi devices may be selected by the user.

Before determining the smart WiFi device to be configured, the terminal further needs to obtain the user's identity information and verify the obtained user's identity information. Only after the verification passes can the terminal determine the smart WiFi device to be configured according to the user's actual demands to ensure only a user having a right can perform configuration for the smart WiFi device. Optionally, the user's identity information may be account password, speech, fingerprint, head photo and the like. This is not limited by the present disclosure.

In 202, the terminal uses an external AP function of the smart WiFi device to establish a connection with the smart WiFi device.

In this step, the terminal is in a station mode, and the smart WiFi device determined by the terminal is in an AP mode. The terminal in the station mode can use the external AP function of the smart WiFi device to detect the smart WiFi device in the AP mode. After the terminal detects the smart WiFi device to be configured, the terminal sends a connection establishment request to the smart WiFi device and establishes the connection with the smart WiFi device after handshake for predetermined times. The external AP function of the smart WiFi device may be considered as the function when a WiFi module in the smart WiFi device is in an AP mode. The device in the station mode can detect the device in the AP mode. With the external AP function of the smart WiFi device, the present disclosure implements the terminal's access to the smart WiFi device and then perform network configuration.

Preferably, in this step, the connection request sent by the terminal to the smart WiFi device may be a TCP connection request. After the terminal sends the TCP connection request to the smart WiFi device, after the terminal and the smart WiFi device undergo three times of handshake needed by the TCP connection, the terminal establishes the TCP connection with the smart WiFi device to be configured.

In 203, the terminal obtains network configuration information.

In the step, the network configuration information obtained by the terminal comprises network name and network password, namely, the obtained network configuration information enables the smart WiFi device to connect with the network.

Optionally, in a specific implementation procedure of the present embodiment, it is feasible that the terminal obtains user-input network configuration information, for example, the terminal offers an available WiFi list, the user selects and then inputs a password corresponding to the selected WiFi network, and the terminal considers the name of the user-selected network and the input password as the network configuration information. It is further feasible that the terminal obtains network configuration information already stored locally, for example, after the user completes configuration one time, the used network configuration information is stored, and then the terminal uses, by default, the already-stored network configuration information to configure other smart WiFi devices.

Optionally, in a specific implementation procedure of the present embodiment, after obtaining the network configuration information, the terminal may verify the obtained network configuration information. Verification involves verifying whether the network corresponding to the network name and network password in the network configuration information is available, verifying whether an uplink extranet of the network is smooth if the network is available, and, if the uplink extranet is smooth, determining verification of the obtained network configuration information successful. In the case of the successful verification, the terminal can send the obtained network configuration information to the smart WiFi device through the established connection. In the case of unsuccessful verification, the terminal returns causes of failure to verify to the user, for example, “network password error” or “failed to connect the extranet”, to prompt the user to make amendments. It is further feasible to, after obtaining the network configuration information, consider the obtained network configuration information accurate by default.

In 204, the terminal sends the network configuration information to the smart WiFi device through the connection so that the smart WiFi device performs configuration according to the sent network configuration information.

In this step, the terminal sends the network configuration information to the smart WiFi device through the established connection, and the smart WiFi device, after receiving the network configuration information sent by the terminal, connects with the network according to the network name and network password, and completes network configuration.

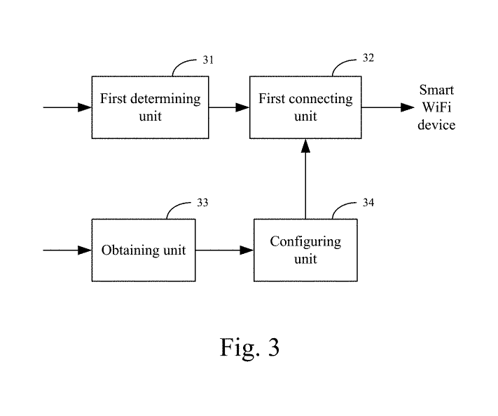

Detailed depictions will be given to the structural schematic diagram of the configuring apparatus according to an embodiment of the present disclosure. As shown in FIG. 3, the apparatus is located at a terminal and comprises a first determining unit 31, a first connecting unit 32, an obtaining unit 33 and a configuring unit 34.

The first determining unit 31 is configured to determine the smart WiFi device to be configured.

The first determining unit 31 determines the smart WiFi device to be configured according to the user's actual demands.

In the present disclosure, the terminal may be a mobile device such as a mobile phone, a notebook computer, a tablet computer or a PDA (Personal Digital Assistant). The present disclosure does not limit the type of the terminal.

Optionally, in a specific implementing procedure of the present embodiment, the first determining unit 31 may, according to a name of the smart WiFi device input by the user, determine the smart WiFi device corresponding to the name as the smart WiFi device to be configured. For example, if the user inputs “ [symbol] (Gree air conditioner)”, the first determining unit 31 determines “ [symbol] ” as the smart WiFi device to be configured; if there are multiple smart WiFi devices of the same type in the room, the user may input more detailed information to ensure the smart WiFi device determined by the first determining unit 31 as the smart WiFi device that the user actually needs to configure, for example, the user may input “ [symbol] (bedroom Gree air conditioner)”, and the first determining unit 31 may determine the bedroom Gree air conditioner as the smart WiFi device to be configured. It is further possible that after scanning the smart WiFi device, the first determining unit 31 determine the smart WiFi device selected by the user from the scanned smart WiFi devices as the smart WiFi device to be configured. The first determining unit 31 obtains all smart WiFi devices in the room by scanning to ensure that un-configured or newly-installed smart WiFi devices may be selected by the user.

Before determining the smart WiFi device to be configured, the first determining unit 31 needs to obtain the user's identity information and verify the obtained user's identity information. Only after the verification passes can the first determining unit 31 determine the smart WiFi device to be configured according to the user's actual demands to ensure only a user having a right can perform configuration for the smart WiFi device. Optionally, the user's identity information may be account password, speech, fingerprint, head photo and the like. This is not limited by the present disclosure.

The first connecting unit 32 is configured to use an external AP function of the smart WiFi device to establish a connection with the smart WiFi device.

The first connecting unit 32 is in a station mode, and the smart WiFi device determined by the first connecting unit 32 is in an AP mode. The first connecting unit 32 in the station mode can use the external AP function of the smart WiFi device to detect the smart WiFi device in the AP mode. After the first connecting unit 32 detects the smart WiFi device to be configured, the first connecting unit 32 sends a connection establishment request to the smart WiFi device and establishes the connection with the smart WiFi device after handshake for predetermined times. The external AP function of the smart WiFi device may be considered as the function when a WiFi module in the smart WiFi device is in an AP mode. The device in the station mode can detect the device in the AP mode. With the external AP function of the smart WiFi device, the present disclosure implements the terminal's access to the smart WiFi device and then perform network configuration.

Preferably, the connection request sent by the first connecting unit 32 to the smart WiFi device is a TCP connection request. After the first connecting unit 32 and the smart WiFi device undergo three times of handshake needed by the TCP connection, the first connecting unit 32 establishes the TCP connection with the smart WiFi device to be configured.

The obtaining unit 33 is configured to obtain network configuration information.

The network configuration information obtained by the obtaining unit 33 comprises network name and network password, namely, the obtained network configuration information enables the smart WiFi device to connect with the network.

Optionally, in a specific implementation procedure of the present embodiment, it is feasible that the obtaining unit 33 obtains user-input network configuration information, for example, the terminal offers an available WiFi list, the user selects and then inputs a password corresponding to the selected WiFi network, and the obtaining unit 33 considers the name of the user-selected network and the input password as the network configuration information. It is further feasible that the obtaining unit 33 obtains network configuration information already stored locally, for example, after the user completes configuration one time, the used network configuration information is stored, and then the obtaining unit 33 uses, by default, the already-stored network configuration information to configure other smart WiFi devices.

Optionally, in a specific implementation procedure of the present embodiment, after obtaining the network configuration information, the obtaining unit 33 may verify the obtained network configuration information. The obtaining unit 33 verifies whether the network corresponding to the network name and network password in the network configuration information is available, the obtaining unit 33 verifies whether an uplink extranet of the network is smooth if the network is available, and, if the uplink extranet is smooth, determines verification of the obtained network configuration information successful. In the case of the successful verification, the obtaining unit 33 sends the obtained network configuration information to the smart WiFi device through the established connection. In the case of unsuccessful verification, the obtaining unit 33 returns causes of failure to verify to the user, for example, “wrong network password” or “failed to connect the extranet”, to prompt the user to make amendments. It is further feasible that, after obtaining the network configuration information, the obtaining unit 33 considers the obtained network configuration information accurate by default.

The configuring unit 34 is configured to send the network configuration information to the smart WiFi device through the connection so that the smart WiFi device performs configuration according to the sent network configuration information.

The configuring unit 34 sends the network configuration information to the smart WiFi device through the connection established by the first connecting unit 32, and the smart WiFi device, after receiving the network configuration information sent by the configuring unit 34, connects with the network according to the network name and network password, and thereby completes network configuration of the smart WiFi device.

When the smart WiFi device malfunctions, the user is usually not aware of the cause of the fault and the user usually restores factory setting of the smart WiFi device or asks a professional for repair. When the smart WiFi device is repaired by restoring the factory setting, this may cause certain damages to the device; when the device is repaired by a professional on the spot, the costs are higher. Therefore, the present disclosure provides a method of maintaining the smart WiFi device. Through the connection established by the smart WiFi device, the terminal obtains the cause of the fault of the smart WiFi device, and obtains a corresponding solution according to the cause of the fault, thereby implementing self-maintenance of the smart WiFi device, reducing the user's costs and improving the maintenance efficiency.

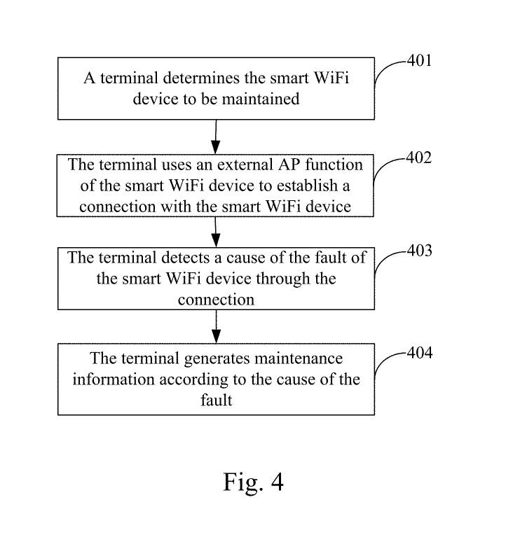

FIG. 4 is a flow chart of a method of maintaining the smart WiFi device according to an embodiment of the present disclosure. As shown in FIG. 4, the method comprises:

In 401, the terminal determines the smart WiFi device to be maintained.

In this step, the terminal determines the smart WiFi device to be maintained according to the user's actual demands.

In the present disclosure, the terminal may be a mobile device such as a mobile phone, a notebook computer, a tablet computer or a PDA (Personal Digital Assistant). The present disclosure does not limit the type of the terminal.

Optionally, in a specific implementing procedure of the present embodiment, according to a name of the smart WiFi device input by the user, the terminal determines the smart WiFi device corresponding to the name as the smart WiFi device to be maintained. It is further possible that after scanning the smart WiFi device, the terminal determines the smart WiFi device selected by the user from the scanned smart WiFi devices as the smart WiFi device to be maintained. The terminal obtains all smart WiFi devices in the room by scanning to ensure that all smart WiFi devices can be selected by the user. It is further feasible that the terminal, according to the name of the smart WiFi device sent by a server, determines the smart WiFi device corresponding to the name as the smart WiFi device to be maintained. After the smart WiFi device is connected to the network, the server corresponding to each class of smart WiFi devices monitors the smart WiFi device. If the server finds that a certain smart WiFi device malfunctions, it sends the name of the smart WiFi device to the terminal, and then the terminal, according to the name of the smart WiFi device sent by the server, determines the smart WiFi device corresponding to the name as the smart WiFi device to be maintained.

Before determining the smart WiFi device to be maintained, the terminal needs to obtain the user's identity information and verify the obtained user's identity information. Only after the verification passes can the terminal determine the smart WiFi device to be maintained according to the user's actual demands to ensure only a user having a right can perform maintenance for the smart WiFi device. Optionally, the user's identity information may be account password, speech, fingerprint, head photo and the like. This is not limited by the present disclosure.

In 402, the terminal uses an external AP function of the smart WiFi device to establish a connection with the smart WiFi device.

In this step, the terminal is in a station mode, and the smart WiFi device determined by the terminal is in an AP mode. The terminal in the station mode can use the external AP function of the smart WiFi device to detect the smart WiFi device in the AP mode. After the terminal detects the smart WiFi device to be configured, the terminal sends a connection establishment request to the smart WiFi device and establishes the connection with the smart WiFi device after handshake for predetermined times.

Preferably, in this step, the connection request sent by the terminal to the smart WiFi device may be a TCP connection request. After the terminal sends the connection request to the smart WiFi device, after three times of handshake needed by the TCP connection, the terminal establishes the TCP connection with the smart WiFi device to be configured.

In 403, the terminal detects a cause of the fault of the smart WiFi device through the connection.

In this step, a detection instruction is sent to the smart WiFi device to be maintained through the established connection; after receiving the detection instruction sent by the terminal, the smart WiFi device detects its own state; upon completion of the detection, the smart WiFi device returns state information obtained from the detection to the terminal, and the terminal obtains the cause of the fault according to the state information returned by the smart WiFi device.

After receiving the detection instruction, the smart WiFi device detects its own state and obtains state information, for example, returns failure to connect to the network, internal process error, function abnormity or the like. Then, the smart WiFi device sends the obtained state information to the terminal through the connection established with the terminal, and then the terminal obtains the cause of the fault according to the state information sent by the smart WiFi device. For example, the state information obtained by the smart WiFi device is failure to connect to the network, it is possible to check the network configuration information allocated to the smart WiFi device last time, and determine whether abnormity exists, for example, check to find that the network password is wrong, and thereby obtain the cause of the fault of the smart WiFi device is network password error. For another example, if the smart WiFi device runs an internal process wrongly, the cause of the fault of the smart WiFi device obtained by the terminal according to the state information is an internal process error of the device.

There also exist some cases in which the terminal fails to scan the smart WiFi device in 401, or fails to establish the connection with the smart WiFi device in 402, the cause of the fault such as power failure, crash or connection abnormity of the smart WiFi device can be obtained.

In 404, the terminal generates maintenance information according to the cause of the fault.

In this step, according to the cause of the fault obtained in step 403, the terminal obtains a solution corresponding to the cause of the fault and provides the obtained fault-solving solution to the user.

For example, if the cause of the fault of the smart WiFi device obtained by the terminal is network password error, the user might alter the network password, and a solution of re-inputting a network password is provided to the user; if the obtained cause of the fault is that the uplink network cannot be connected to the extranet, it is possible that the extranet is confronted with a problem such as repair or arrears, and a solution of checking whether the extranet is normal and inquiring to the extranet customer service center is provided to the user; if the obtained cause of the fault is an internal process error of the smart WiFi device, a solution of re-activating the smart WiFi device is prompted to the user.

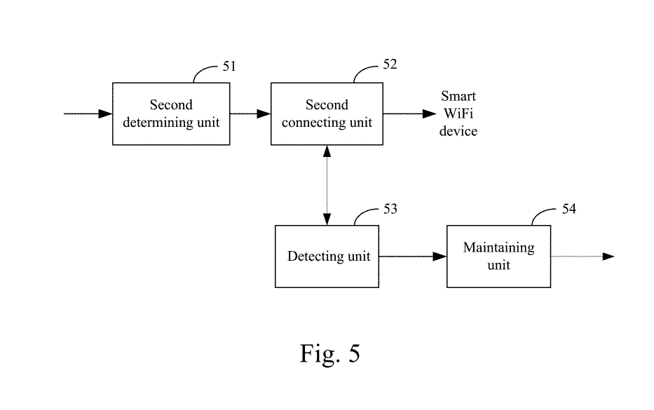

Detailed depictions will be given to the structural schematic diagram of a maintaining apparatus according to an embodiment of the present disclosure. As shown in FIG. 5, the apparatus is located at a terminal and comprises a second determining unit 51, a second connecting unit 52, a detecting unit 53 and a maintaining unit 54.

The second determining unit 51 is configured to determine the smart WiFi device to be maintained.

In the present disclosure, the terminal may be a mobile device such as a mobile phone, a notebook computer, a tablet computer or a PDA (Personal Digital Assistant). The present disclosure does not limit the type of the terminal.

The second determining unit 51 determines the smart WiFi device to be maintained according to the user's actual needs.

Optionally, in a specific implementing procedure of the present embodiment, according to a name of the smart WiFi device input by the user, the second determining unit 51 determines the smart WiFi device corresponding to the name as the smart WiFi device to be maintained. It is further possible that after scanning the smart WiFi device, the second determining unit 51 determines the smart WiFi device selected by the user from the scanned smart WiFi devices as the smart WiFi device to be maintained. The second determining unit 51 obtains all smart WiFi devices in the room by scanning to ensure that all smart WiFi devices can be selected by the user. It is further feasible that the second determining unit 51, according to the name of the smart WiFi device sent by a server, determines the smart WiFi device corresponding to the name as the smart WiFi device to be maintained. After the smart WiFi device is connected to the network, the server corresponding to each class of smart WiFi devices monitors the smart WiFi device. If the server finds that a certain smart WiFi device malfunctions, it sends the name of the smart WiFi device to the terminal, and then the second determining unit 51, according to the name of the smart WiFi device sent by the server, determines the smart WiFi device corresponding to the name as the smart WiFi device to be maintained.

Before determining the smart WiFi device to be maintained, the second determining unit 51 needs to obtain the user's identity information and verify the obtained user's identity information. Only after the verification passes can the second determining unit 51 determine the smart WiFi device to be maintained according to the user's actual demands to ensure only a user having a right can perform maintenance for the smart WiFi device. Optionally, the user's identity information may be account password, speech, fingerprint, head photo and the like. This is not limited by the present disclosure.

The second connecting unit 52 uses an external AP function of the smart WiFi device to establish a connection with the smart WiFi device.

The second connecting unit 52 is in a station mode, and the smart WiFi device determined by the second determining unit 51 is in an AP mode. The second connecting unit 52 in the station mode can use the external AP function of the smart WiFi device to detect the smart WiFi device in the AP mode. After the second connecting unit 52 detects the smart WiFi device to be configured, the second connecting unit 52 sends a connection establishment request to the smart WiFi device and then establishes the connection with the smart WiFi device after handshake for predetermined times.

Preferably, the connection request sent by the second connecting unit 52 to the smart WiFi device may be a TCP connection request. After the second connecting unit 52 and the smart WiFi device undergo three times of handshake needed by the TCP connection, the second connecting unit 52 establishes the TCP connection with the smart WiFi device to be configured.

The detecting unit 53 detects the cause of the fault of the smart WiFi device through the connection.

The detecting unit 53 sends a detection instruction to the smart WiFi device to be maintained through the connection established by the second connecting unit 52; after receiving the detection instruction sent by the terminal, the smart WiFi device detects its own state; upon completion of the detection, the smart WiFi device returns state information obtained from the detection to the terminal, and the detecting unit 53 obtains the cause of the fault according to the state information returned by the smart WiFi device.

After receiving the detection instruction sent by the detecting unit 53, the smart WiFi device detects its own state, including detecting the network configuration information and operation information. The network configuration information is the network configuration information used to configure the smart WiFi device last time. When the network configuration information is detected, detection is carried out for whether the network name and network password are useable and whether the uplink extranet is smooth. The operation information is the operation state of the smart WiFi device itself. When the operation information is detected, detection is carried out for whether the internal process of the smart WiFi device is erroneous and whether some function modules malfunction.

After receiving the detection instruction sent by the detecting unit 53, the smart WiFi device detects its own state and obtains state information, for example, returns failure to connect to the network, internal process error, function abnormity or the like. Then, the smart WiFi device sends the obtained state information to the detecting unit 53 through the connection established with the terminal, and then the detecting unit 53 obtains the cause of the fault according to the state information sent by the smart WiFi device. For example, the state information obtained by the smart WiFi device is failure to connect to the network, it is possible to check the network configuration information allocated to the smart WiFi device last time, and determine whether abnormity exists, for example, check to find that the network password is wrong, and thereby obtain the cause of the fault of the smart WiFi device is network password error. For another example, if the smart WiFi device runs an internal process wrongly, the cause of the fault of the smart WiFi device obtained by the terminal according to the state information is occurrence of an error in the device.

There also exist some cases in which the second determining unit 51 fails to scan the smart WiFi device in, or the second connecting unit 52 fails to establish the connection with the smart WiFi device, the cause of the fault such as power failure, crash or connection abnormity of the smart WiFi device can be obtained.

The maintaining unit 54 generates maintenance information according to the cause of the fault.

According to the cause of the fault obtained by the detecting unit 53, the maintaining unit 54 obtains a solution corresponding to the cause of the fault and provides the obtained fault-solving solution to the user.

For example, if the cause of the fault obtained by the maintaining unit 54 is network password error, the user might alter the network password, and a solution of re-inputting a network password is provided to the user; if the obtained cause of the fault obtained by the maintaining unit 54 is that the uplink network cannot be connected to the extranet, it is possible that the extranet is confronted with a problem such as repair or arrears, and a solution of checking whether the extranet is normal and inquiring to the extranet customer service center is provided to the user; if the cause of the fault obtained by the maintaining unit 54 is an internal process error of the smart WiFi device, a solution of re-activating the smart WiFi device is prompted to the user.

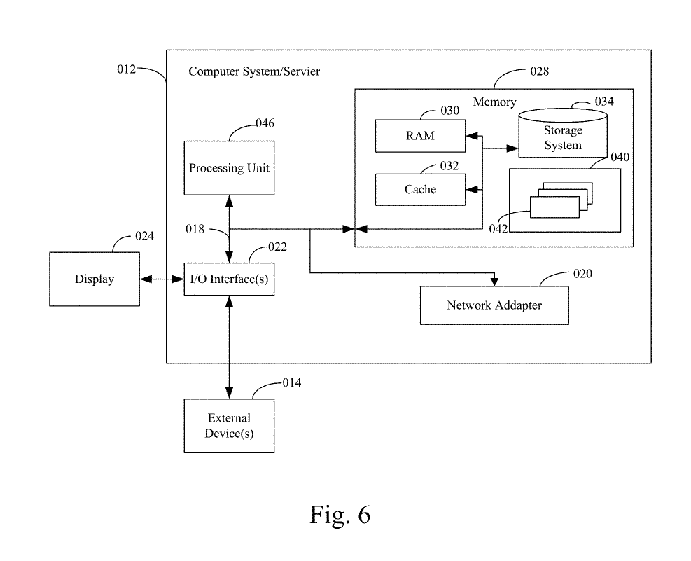

FIG. 6 illustrates a block diagram of an example computer system/server 012 adapted to implement an implementation mode of the present disclosure. The computer system/server 012 shown in FIG. 6 is only an example and should not bring about any limitation to the function and scope of use of the embodiments of the present disclosure.

As shown in FIG. 6, the computer system/server 012 is shown in the form of a general-purpose computing device. The components of computer system/server 012 may include, but are not limited to, one or more processors or processing units 016, a memory 028, and a bus 018 that couples various system components including system memory 028 and the processor 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

Memory 028 can include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 can be provided for reading from and writing to a non-removable, non-volatile magnetic media (not shown in FIG. 6 and typically called a “hard drive”). Although not shown in FIG. 6, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 018 by one or more data media interfaces. The memory 028 may include at least one program product having a set (e.g., at least one) of program modules that are configured to carry out the functions of embodiments of the present disclosure.

Program/utility 040, having a set (at least one) of program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc.; with one or more devices that enable a user to interact with computer system/server 012; and/or with any devices (e.g., network card, modem, etc.) that enable computer system/server 012 to communicate with one or more other computing devices. Such communication can occur via Input/Output (I/O) interfaces 022. Still yet, computer system/server 012 can communicate with one or more networks such as a local area network (LAN), a general wide area network (WAN), and/or a public network (e.g., the Internet) via network adapter 020. As depicted in FIG. 6, network adapter 020 communicates with the other communication modules of computer system/server 012 via bus 018. It should be understood that although not shown, other hardware and/or software modules could be used in conjunction with computer system/server 012.

Examples, include, but are not limited to: microcode, device drivers, redundant processing units, external disk drive arrays, RAID systems, tape drives, and data archival storage systems, etc.

The processing unit 016 executes various function applications and data processing by running programs stored in the memory 028, for example, implements a method of configuring the smart WiFi device, comprising:

the terminal determines the smart WiFi device to be configured;

the terminal uses an external AP function of the smart WiFi device to establish a connection with the smart WiFi device;

the terminal obtains configuration information;

the terminal sends the configuration information to the smart WiFi device through the connection so that the smart WiFi device performs configuration according to the sent configuration information.

Or implements a method of maintaining the smart WiFi device, comprising:

the terminal determines the smart WiFi device to be maintained;

the terminal uses an external AP function of the smart WiFi device to establish a connection with the smart WiFi device;

the terminal detects a cause of the fault of the smart WiFi device through the connection;

the terminal generates maintenance information according to the cause of the fault.

The aforesaid computer program may be arranged in the computer storage medium, namely, the computer storage medium is encoded with the computer program. The program, when executed by one or more computers, enables one or more computers to execute the flow of the method and/or operations of the apparatus as shown in the above embodiments of the present disclosure. For example, the flow of the method performed by the one or more processors may comprise a method of configuring the smart WiFi device, comprising:

the terminal determines the smart WiFi device to be configured;

the terminal uses an external AP function of the smart WiFi device to establish a connection with the smart WiFi device;

the terminal obtains configuration information;

the terminal sends the configuration information to the smart WiFi device through the connection so that the smart WiFi device performs configuration according to the sent configuration information.

Or the flow of the method may comprise a method of maintaining the smart WiFi device, comprising:

the terminal determines the smart WiFi device to be maintained;

the terminal uses an external AP function of the smart WiFi device to establish a connection with the smart WiFi device;

the terminal detects a cause of the fault of the smart WiFi device through the connection;

the terminal generates maintenance information according to the cause of the fault.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

According to the technical solutions provided by the present disclosure, the connection is established between the terminal and the smart WiFi device through the external AP function of the smart WiFi device, and the terminal may be used to implement configuration and maintenance of the smart WiFi device, thereby simplifying the user's operation steps and improving the user's configuration efficiency and maintenance efficiency.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method of configuring a smart WiFi device, executed by a terminal, wherein the method comprises:
determining the smart WiFi device to be configured;
using an external AP function of the smart WiFi device to establish a connection with the smart WiFi device;
obtaining configuration information;
sending the configuration information to the smart WiFi device through the connection so that the smart WiFi device performs configuration according to the sent configuration information.

2. The method according to claim 1, wherein the determining the smart WiFi device to be configured comprises:
according to a name of the smart WiFi device input by the user, determining the smart WiFi device corresponding to the name as the smart WiFi device to be configured; or
after scanning the smart WiFi device, determining a smart WiFi device selected by the user from the scanned smart WiFi devices as the smart WiFi device to be configured.

3. The method according to claim 2, wherein before the determining the smart WiFi device to be configured, the method further comprises:
obtaining the user's identity information;
verifying the user's identity information.

4. The method according to claim 1, wherein the using an external AP function of the smart WiFi device to establish a connection with the smart WiFi device comprises:
while the terminal is in a station mode, detecting the smart WiFi device in an AP mode;
sending a connection establishment request to the smart WiFi device;
establishing the connection with the smart WiFi device after handshake for predetermined times.

5. The method according to claim 1, wherein the obtaining configuration information comprises:
obtaining user-input configuration information or obtaining configuration information already stored locally.

6. The method according to claim 1, wherein after the obtaining the configuration information, the method further comprises:
verifying the obtained configuration information;
if the verification passes, continuing to send the configuration information to the smart WiFi device through the connection.

7. A method of maintaining a smart WiFi device, executed by a terminal, wherein the method comprises:
determining the smart WiFi device to be maintained;
using an external AP function of the smart WiFi device to establish a connection with the smart WiFi device;
detecting a cause of the fault of the smart WiFi device through the connection;
generating maintenance information according to the cause of the fault.

8. The method according to claim 7, wherein the determining the smart WiFi device to be maintained comprises:
according to a name of the smart WiFi device input by the user, determining the smart WiFi device corresponding to the name as the smart WiFi device to be maintained; or
after scanning the smart WiFi device, determining a smart WiFi device selected by the user from the scanned smart WiFi devices as the smart WiFi device to be maintained; or
according to the name of the smart WiFi device sent by a server, determining the smart WiFi device corresponding to the name as the smart WiFi device to be maintained.

9. The method according to claim 8, wherein before the determining the smart WiFi device to be maintained, the method further comprises:
obtaining the user's identity information;
verifying the user's identity information.

10. The method according to claim 7, wherein the establishing the connection with the smart WiFi device after determining the smart WiFi device to be maintained comprises:
while the terminal is in a station mode, detecting the smart WiFi device in an AP mode;
sending a connection establishment request to the smart WiFi device;
establishing the connection with the smart WiFi device after handshake for predetermined times.

11. The method according to claim 7, wherein the detecting the cause of the fault of the smart WiFi device through the connection comprises:
sending a detection instruction to the smart WiFi device through the established connection;
obtaining state information returned by the smart WiFi device;
obtaining the cause of the fault according to the state information.

12. The method according to claim 7, wherein the generating maintenance information according to the cause of the fault comprises:
obtaining a solution corresponding to the cause of the fault according to the cause of the fault;
providing the solution to the user.

13. A terminal, wherein the terminal comprises:
one or more processors;
a memory for storing one or more programs,
said one or more programs are executed by said one or more processors to enable said one or more processors to implement the following operation:
determining the smart WiFi device to be configured;
using an external AP function of the smart WiFi device to establish a connection with the smart WiFi device;
obtaining configuration information;
sending the configuration information to the smart WiFi device through the connection so that the smart WiFi device performs configuration according to the sent configuration information.

14. A terminal, wherein the terminal comprises:
one or more processors;
a memory for storing one or more programs,
said one or more programs are executed by said one or more processors to enable said one or more processors to implement the following operation:
determining the smart WiFi device to be maintained;
using an external AP function of the smart WiFi device to establish a connection with the smart WiFi device;
detecting a cause of the fault of the smart WiFi device through the connection;
generating maintenance information according to the cause of the fault.

15. A computer storage medium comprising computer-executable instructions, the computer-executable instructions being used to implement the following operation when the computer-executable instructions are executed by a computer processor:
determining the smart WiFi device to be configured;
using an external AP function of the smart WiFi device to establish a connection with the smart WiFi device;
obtaining configuration information;
sending the configuration information to the smart WiFi device through the connection so that the smart WiFi device performs configuration according to the sent configuration information.

16. A computer storage medium comprising computer-executable instructions, the computer-executable instructions being used to implement the following operation when the computer-executable instructions are executed by a computer processor;
determining the smart WiFi device to be maintained;
using an external AP function of the smart WiFi device to establish a connection with the smart WiFi device;
detecting a cause of the fault of the smart WiFi device through the connection;
generating maintenance information according to the cause of the fault.

17. The terminal according to claim 13, wherein the determining the smart WiFi device to be configured comprises:
according to a name of the smart WiFi device input by the user, determining the smart WiFi device corresponding to the name as the smart WiFi device to be configured; or
after scanning the smart WiFi device, determining a smart WiFi device selected by the user from the scanned smart WiFi devices as the smart WiFi device to be configured.

18. The terminal according to claim 17, wherein before the determining the smart WiFi device to be configured, the operation further comprises:
obtaining the user's identity information;
verifying the user's identity information.

19. The terminal according to claim 13, wherein the using an external AP function of the smart WiFi device to establish a connection with the smart WiFi device comprises:
while the terminal is in a station mode, detecting the smart WiFi device in an AP mode;
sending a connection establishment request to the smart WiFi device;
establishing the connection with the smart WiFi device after handshake for predetermined times.

20. The terminal according to claim 13, wherein the obtaining configuration information comprises:
obtaining user-input configuration information or obtaining configuration information already stored locally.

21. The terminal according to claim 13, wherein after the obtaining the configuration information, the operation further comprises:
verifying the obtained configuration information;
if the verification passes, continuing to send the configuration information to the smart WiFi device through the connection.

22. The terminal according to claim 14, wherein before the determining the smart WiFi device to be maintained, the operation further comprises:
obtaining the user's identity information;
verifying the user's identity information.

23. The terminal according to claim 14, wherein the establishing the connection with the smart WiFi device after determining the smart WiFi device to be maintained comprises:
while the terminal is in a station mode, detecting the smart WiFi device in an AP mode;
sending a connection establishment request to the smart WiFi device;
establishing the connection with the smart WiFi device after handshake for predetermined times.

24. The terminal according to claim 14, wherein the detecting the cause of the fault of the smart WiFi device through the connection comprises:
sending a detection instruction to the smart WiFi device through the established connection;
obtaining state information returned by the smart WiFi device;
obtaining the cause of the fault according to the state information.

25. The terminal according to claim 14, wherein the generating maintenance information according to the cause of the fault comprises:
obtaining a solution corresponding to the cause of the fault according to the cause of the fault;
providing the solution to the user.

26. The computer storage medium according to claim 15, wherein the determining the smart WiFi device to be configured comprises:
according to a name of the smart WiFi device input by the user, determining the smart WiFi device corresponding to the name as the smart WiFi device to be configured; or
after scanning the smart WiFi device, determining a smart WiFi device selected by the user from the scanned smart WiFi devices as the smart WiFi device to be configured.

27. The computer storage medium according to claim 26, wherein before the determining the smart WiFi device to be configured, the operation further comprises:
obtaining the user's identity information;
verifying the user's identity information.

28. The computer storage medium according to claim 15, wherein the using an external AP function of the smart WiFi device to establish a connection with the smart WiFi device comprises:
detecting the smart WiFi device in an AP mode;
sending a connection establishment request to the smart WiFi device;
establishing the connection with the smart WiFi device after handshake for predetermined times.

29. The computer storage medium according to claim 15, wherein the obtaining configuration information comprises:
obtaining user-input configuration information or obtaining configuration information already stored locally.

30. The computer storage medium according to claim 15, wherein after the obtaining the configuration information, the operation further comprises:
verifying the obtained configuration information;
if the verification passes, continuing to send the configuration information to the smart WiFi device through the connection.

31. The computer storage medium according to claim 16, wherein before the determining the smart WiFi device to be maintained, the operation further comprises:
obtaining the user's identity information;
verifying the user's identity information.

32. The computer storage medium according to claim 16, wherein the establishing the connection with the smart WiFi device after determining the smart WiFi device to be maintained comprises:
detecting the smart WiFi device in an AP mode;
sending a connection establishment request to the smart WiFi device;
establishing the connection with the smart WiFi device after handshake for predetermined times.

33. The computer storage medium according to claim 16, wherein the detecting the cause of the fault of the smart WiFi device through the connection comprises:
sending a detection instruction to the smart WiFi device through the established connection;
obtaining state information returned by the smart WiFi device;
obtaining the cause of the fault according to the state information.

34. The computer storage medium according to claim 16, wherein the generating maintenance information according to the cause of the fault comprises:
obtaining a solution corresponding to the cause of the fault according to the cause of the fault;
providing the solution to the user.
